(19) United States
(12) Patent Application Publication
(10) Pub. No.: US 2013/0102263 A1
(43) Pub. Date: Apr. 25, 2013

(54) RADIOFREQUENCY TRANSMITTER WITH A METAL/PLASTIC HETEROGENEOUS STRUCTURE

(71) Applicants: Olivier FORGERIT, Toulouse (FR); Gilles JUREK, Toulouse (FR)

(72) Inventors: Olivier FORGERIT, Toulouse (FR); Gilles JUREK, Toulouse (FR)

(73) Assignees: CONTINENTAL AUTOMOTIVE GMBH, Hannover (DE); CONTINENTAL AUTOMOTIVE FRANCE, Toulouse (FR)

(21) Appl. No.: 13/597,294

(22) Filed: Aug. 29, 2012

(30) Foreign Application Priority Data
Oct. 21, 2011 (FR) 1103227

(51) Int. Cl. H04B 1/03; H01P 11/00

(52) U.S. Cl. 455/128; 29/600

(57) ABSTRACT

A radiofrequency transmitter (1) including two plastic covers (61, 62) arranged one on top of the other, enclosing a printed circuit (5), and having a metal belt (3) inserted between the covers in their joining area, characterized in that an internal portion of the metal belt (3) is fixed in at least one recess (212) created between the two plastic covers (61, 62). A method for assembling a radiofrequency transmitter (1) including a step of assembling the different parts forming the transmitter (1) is also described.

The present invention relates to the field of radiofrequency transmitters, and more particularly a radiofrequency transmitter with a metal/plastic heterogeneous structure.

The radiofrequency transmitter addressed by the present invention is, for example, of the type used with a motor vehicle key to remotely control the opening or the closing of the doors thereof or even to start the latter.

It is in fact commonplace for the keys of motor vehicles to be associated with remote control devices, housed in the head of the key or in an associated key holder, generally in the form of a housing. Together with the constraints of compactness of these devices, there are external attacks associated with test and usage conditions which are sometimes difficult, and, for example, impacts, drops, contacts with water, pulling forces on the key holder attachment ring, electrostatic discharges due to handling, which mean that these devices have to be particularly robust and protected, both for tightness and for resistance to impacts.

Such a transmitter therefore generally takes the form of a housing which has two plastic half-shells or covers, potentially painted and lacquered, containing at least one printed circuit and a gasket. For the new generation transmitters, these two covers are complemented with a metal belt.

Generally, this metal belt is fixed to the two plastic covers by screwing, riveting, gluing or may be over-molded. Indeed the heterogeneous structure of the transmitter due to the presence of the metal belt and of the plastic covers does not allow for fixing methods such as ultrasound welding.

The screwing and riveting techniques present the drawback of complicating the structure of the belt and of the covers with the fixing of the rivets or screws, and of making the transmitter heavier and less compact and above all of generating significant costs.

The aim of the present invention is therefore to mitigate one or more of the drawbacks of the prior art by proposing a radiofrequency transmitter with a heterogeneous structure which is tight, very compact and which is simple and quick to assemble.

For this, the present invention proposes a radiofrequency transmitter with a heterogeneous structure comprising two plastic covers arranged one on top of the other, enclosing a printed circuit, and having a metal belt inserted between the covers in their joining area, an internal portion of the metal belt being fixed in at least one recess created between the two plastic covers.

In this way, the metal belt is immobilized, it cannot therefore rotate or be removed.

According to one embodiment of the invention, the internal portion of the metal belt is discontinuous.

The fact that the portion of the immobilized metal belt is not continuous makes it possible to improve the compactness of the radiofrequency transmitter.

According to one embodiment of the invention, the internal portion of the metal belt has at least one lug formed from the inside of the metal belt and directed toward the interior of the transmitter.

The presence of a lug provides for a better fixing of the belt, while maintaining a total seal-tightness by virtue of the welding together of the plastic parts.

According to one embodiment of the invention, the transmitter comprises a first plastic part and a second plastic part arranged between the two covers, the first plastic part having at least one recess in which a lug of the metal belt is housed.

In this way, the metal belt is immobilized between two plastic parts, which themselves can be welded together. The belt cannot therefore rotate or be removed.

According to one embodiment of the invention, the second plastic part has an end arranged against the first plastic part when there is no lug, and arranged against the lug when there is a lug.

According to one embodiment of the invention, the transmitter comprises a gasket, one end of the gasket is compressed between the second plastic part and the lugs of the metal belt.

According to one embodiment of the invention, the two plastic parts are welded together at least in the portion of the metal belt that does not have any lug.

According to one embodiment of the invention, one end of the printed circuit is arranged between the first plastic part and the gasket.

The invention also relates to a method for assembling a radiofrequency transmitter according to the invention, comprising a step of assembling the different parts forming the transmitter, in the following order:
the first plastic part,
the metal belt,
the printed circuit,
the gasket when present, and
the second plastic part.

According to one implementation of the invention, the assembly method comprises a step of welding the two plastic parts together, at least between the lugs of the metal belt.

Other features and advantages of the invention will be better understood and become more clearly apparent on reading the description given below, by referring to the appended figures given by way of example:

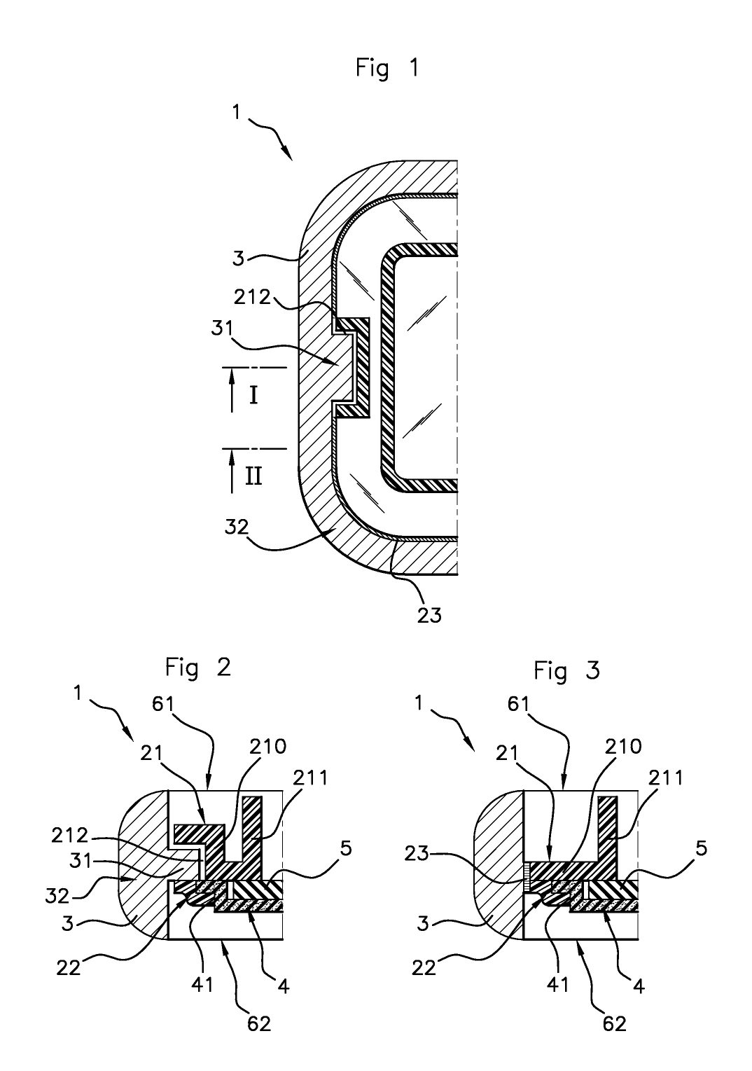

FIG. 1 is a schematic representation of a transversal cross section of the transmitter according to the invention,

FIG. 2 is a schematic representation according to I-I of FIG. 1 of the transmitter according to the invention,

FIG. 3 is a schematic representation of a cross section according to II-II of FIG. 1 of the transmitter according to the invention.

FIG. 1 illustrates a radiofrequency transmitter in transversal cross section.

The radiofrequency transmitter 1 consists of a housing formed by two half-shells or covers 61, 62. These covers are made of plastic materials. Inside the transmitter, there is at least one printed circuit 5 (see FIG. 2).

According to one embodiment of the invention, the transmitter 1 may comprise a gasket 4 (illustrated in FIGS. 2 and 3) which will make it possible to keep the housing tight and protect the printed circuit 5. The transmitter 1 may also comprise components such as light-emitting diodes or lamps. The role of the gasket 4 is therefore to ensure the seal-tightness of a portion of the housing to protect all the components.

The two covers 61, 62, as illustrated in FIGS. 2 and 3, are linked together at their outer edges by a metal or metalized part 3. In other words, the covers 61, 62 are arranged one on top of the other and the part 3 forms a belt 3 which surrounds the housing, formed by the two covers 61, 62, in the area of join between the two covers 61, 62. The belt 3 is thus housed in at least one recess 212 formed between the two covers 61, 62.

The belt 3 may be made of chromium-plated metal, preferably of cast zamak. Zamak is an alloy consisting of zinc, aluminum and magnesium, and sometimes copper. It may also be made of metalized plastic, or any other material other than plastic and forming a heterogeneous structure with the plastic covers 61, 62.

Since direct welding between the belt 3 and each of the two plastic covers 61, 62 is impossible, the applicant had the idea, in order in particular to ensure the seal-tightness of the transmitter 1, of pinching the belt 3 between two plastic parts 21, 22 which can be welded together 23.

FIG. 2 illustrates the arrangement of the plastic parts 21, 22 relative to the belt 3. The first plastic part 21 is arranged in the first cover 61, the second plastic part 22 is arranged in the second cover 62, the two covers 61, 62 being arranged one against the other so that the two plastic parts 21, 22 are inside the housing formed by the two covers 61, 62. A portion of the belt 3, that is to say a portion of the belt located inside the transmitter 1, is positioned between the two plastic parts 21, 22. It is thus possible to weld the two plastic parts 21, 22 together, which will immobilize and fix the belt 3. When the transmitter does not comprise a gasket, the area of weld follows the contours of the lug to ensure the seal-tightness of the housing.

In order to ensure the greatest possible compactness of this assembly, there are alternating metal lugs 31 deriving from the belt 3 and areas of plastic deriving from the covers 61, 62. In other words, the portion of the belt 3 which is pinched between the two plastic parts 21, 22 is not continuous. The metal belt is formed by a solid portion 32, forming the external portion of the belt, having lugs 31 which can be seen in FIGS. 1 and 2 which penetrate toward the interior of the transmitter 1. FIG. 3 illustrates the area of the metal belt 3 that does not have any lug 31. The term “lug” is used to mean a tooth-type elongate portion, formed from the inside of the belt 3 and directed toward the interior of the transmitter 1, which is used to keep the belt 3 fixed between the two plastic parts 21, 22.

The two plastic parts 21, 22 are themselves kept in place by the two covers 61, 62 when they are in the closed position to form the housing.

The first plastic part 21 may consist of two elongate portions 210, 211 arranged perpendicularly relative to one another so as to form an L, when the belt 3 does not have a lug. The first elongate portion 210 is arranged perpendicularly to the metal belt 3 and the second elongate portion 211 is oriented in a direction opposite to that where the second plastic part 22 is located. At the position of each lug 31 of the belt 3, the first portion 210 forms a recess 212 in which the lug 31 of the belt 3 is housed.

The second plastic part 22 has an end placed against the first plastic part 21 when there is no lug 31, and placed against the lug 31 in the area where there is a lug 31. It is thus possible to weld 23 the two plastic parts 21, 22 together in the area where there is no lug 31 in order to ensure the seal-tightness of the housing of the transmitter 1. This second plastic part 22 may consist of two portions arranged so as to form a tread or rebate 41.

The two plastic parts 21, 22 may both be opaque, or both be translucent (or transparent), or opaque for one and translucent (or transparent) for the other.

These two plastic parts 21, 22 may be formed directly in the plastic covers 61, 62.

In the embodiment in which the transmitter comprises a gasket 4, the two plastic parts 21, 22 also compress the gasket 4 which is arranged on an axis parallel to the axis arranged in the extension of the lugs of the belt 3 as illustrated in FIGS. 2 and 3.

One end of the gasket 4 is also compressed between the second plastic part 22 and the lugs 31 of the belt 3 (FIG. 2). This makes it possible to avoid assembly plays and the potential noises resulting therefrom. The gasket 4 forms a tread 41, at its end in contact with the plastic parts 21, 22, which can be seen in FIGS. 2 and 3. This tread enables it to be fitted on one side with the second plastic part 22 and makes it possible to form, on another side, a recess for the printed circuit 5. One end of the printed circuit 5 can thus be arranged between the first plastic part 21 and the gasket 4.

The second plastic part 22 may consist of two portions arranged so as to form a tread or rebate 41 in which the end of the gasket 4 is positioned.

The seal-tightness in the recess, formed by the first plastic part 21 and in which the lug 31 is housed, is produced by the end of the gasket 4 which is compressed between the second plastic part 22 and the lugs 31.

The various parts forming the transmitter are thus arranged in the following order:
the first plastic part 21,
the metal belt 3,
the printed circuit 5,
the gasket 4 when present, and
the second plastic part 22.

The invention also relates to the process of assembling the various parts forming the transmitter 1 in the order as described previously. It also comprises a step of welding the two plastic parts 21, 22 together at the weld 23, between the lugs 31 of the metal belt 3. When the transmitter 1 does not comprise a gasket 4, the area of weld 23 is continuous and follows the contours of the lug to ensure the seal-tightness of the housing. The welding can be done by ultrasound, friction or by laser. When the welding is done by laser, one of the plastic parts must be translucent (or transparent) and the other must be opaque.

The present invention thus proposes a robust and seal-tight radiofrequency transmitter, consisting of simple parts, the assembly of which is simplified, quick and reproducible.

It should be obvious to those skilled in the art that the present invention should not be limited to the details given above and allows for embodiments in numerous other specific forms without departing from the scope of the invention. Consequently, the present embodiments should be considered to be illustrative, and may be modified without, however, departing from the scope defined by the claims.

1. A radiofrequency transmitter (1) with a heterogeneous structure comprising two plastic covers (61, 62) arranged one on top of the other, enclosing a printed circuit (5), and having a metal belt (3) inserted between both of said covers (61, 62) in their joining area, characterized in that an internal portion of the metal belt (3) is fixed in at least one recess (212) created between the two plastic covers (61, 62).

2. The radiofrequency transmitter (1) as claimed in claim 1, characterized in that the internal portion of the metal belt (3) is discontinuous.

3. The radiofrequency transmitter (1) as claimed in claim 1, characterized in that the internal portion of the metal belt (3) has at least one lug (31) formed from the inside of the metal belt (3) and directed toward the interior of the transmitter (1).

4. The radiofrequency transmitter (1) as claimed in claim 1, characterized in that it comprises a first plastic part (21) and a second plastic part (22) arranged between the two plastic covers (61, 62), the first plastic part (21) having at least one recess (212) in which a lug (31) of the metal belt (3) is housed.

5. The radiofrequency transmitter (1) as claimed in claim 1, characterized in that the second plastic part (22) has an end arranged against the first plastic part (21) when there is no lug (31), and arranged against the lug (31) when there is a lug (31).

6. The radiofrequency transmitter (1) as claimed in claim 1, characterized in that it comprises a gasket (4), one end of the gasket (4) is compressed between the second plastic part (22) and the lugs (31) of the metal belt (3).

7. The radiofrequency transmitter (1) as claimed in claim 1, characterized in that the first and the second plastic parts (21, 22) are welded together at least in the portion of the metal belt (3) that does not have any lug (31).

8. The radiofrequency transmitter (1) as claimed in claim 6, characterized in that one end of the printed circuit (5) is arranged between the first plastic part (21) and the gasket (4).

9. A method for assembling a radiofrequency transmitter (1) as claimed in claim 1, characterized in that it comprises a step of assembling the different parts forming the transmitter (1), in the following order:
the first plastic part (21),
the metal belt (3),
the printed circuit (5),
the gasket (4) when present, and
the second plastic part (22).

10. The method for assembling a radiofrequency transmitter (1) as claimed in claim 9, characterized in that it comprises a step of welding the first and second plastic parts (21, 22) together, at least between the lugs (31) of the metal belt (3).

11. The radiofrequency transmitter (1) as claimed in claim 2, characterized in that the internal portion of the metal belt (3) has at least one lug (31) formed from the inside of the metal belt (3) and directed toward the interior of the transmitter (1).

12. The radiofrequency transmitter (1) as claimed in claim 7, characterized in that one end of the printed circuit (5) is arranged between the first plastic part (21) and the gasket (4).
